(19) United States
(12) Patent Application Publication
(10) Pub. No.: US 2003/0000815 A1
(43) Pub. Date: Jan. 2, 2003

(54) Elongate pressure actuated switch

(76) Inventor: Lester E. Burgess, Swarthmore, PA (US)

Correspondence Address: Adrian T. Calderone, Esq., DILWORTH & BARRESE, LLP, 333 Earle Ovington Blvd., Uniondale, NY, 11553, US

(21) Appl. No.: 09/876,752

(22) Filed: Jun. 7, 2001

(51) Int. Cl. H01H 3/16

(52) U.S. Cl. 200/61.43

(57) ABSTRACT

A seamless elongate pressure actuated switch includes a seamless tubular sheath fabricated from a resiliently flexible polymeric resin, and two separate and spaced apart conductive coatings disposed lengthwise along the inside surface of the tubular sheath. The sheath is deformable in response to pressure applied thereto to move the conductive coatings into contact with each other. The conductive coatings are the only means of conducting electricity lengthwise along the inside of the sheath. The thickness of the coatings ranges from about 0.00001 inches to about 0.01 inches. The elongated pressure actuated switch can be made by coating the inside wall of the tubular sheath with a conductive coating and then dividing the conductive coating into two spaced apart portions, or by coextrusion of the spaced apart conductive coatings with the sheath material.

### BACKGROUND

1. Field of the Disclosure

The present disclosure relates to electrical switching devices and particularly to an elongate pressure actuated switch and a method for making same.

2. Description of the Related Art

Various types of elongate pressure actuated electrical switches are known. Typically, such switches are used, for example, for road vehicle detection to survey the amount of traffic using a road, to operate equipment such as traffic signals, warning signals, garage and gate doors, etc.

U.S. Pat. No. 4,762,970 to Brinsley, for example, discloses an elongate pressure actuated cable switch which includes a central elongate conductor, a flexible insulating element helically wound around the central conductor, a flexible tubular body of electrically conductive plastic surrounding the central conductor, two elongate conductors in electrical contact with the outer surface of the flexible tubular body, and an overall insulating sheath of a transverse cross-section of approximately semi-circular shape having a flat surface for supporting the cable switch on the ground. Each outer conductor is embedded in the sheath alongside the flexible electrically conductive tubular body at a position intermediate of the flat surface and the longitudinal axis of the central conductor. When a pressure is applied to a part of the overall outer sheath remote from its flat surface, the central conductor is urged in a direction towards the flat surface to effect electrical contact with the two outer conductors via the flexible electrically conductive tubular body.

U.S. Pat. No. 4,742,196 to Kelly discloses an elongate pressure actuated electrical switch which includes a flexible insulative tubular body having a bore and incorporating at opposed locations around its periphery two sectoral portions of electrically conductive material. Elongate conductors extend lengthwise in electrical contact with the conductive sectoral portions. An overall outer sheath surrounds the tubular body. When pressure is downwardly applied to the sheath the opposed electrically conductive sectoral portions are pressed into contact with each other to effect electrical connection between the conductors.

U.S. Pat. No. 5,728,983 to Ishihara et al. discloses a pressure sensitive cable switch which includes a pair of metallic conductors arranged in opposing relation to one another on the neutral axis for bending within the cross section of a rubber tube, and extend in the longitudinal direction of the tube. A pair of belt shaped electrodes made of conductive rubber material or other conductive materials and embedding the metallic conductors therein, are disposed to oppose each other on the inner circumferential surface of the tube with respect to the neutral axis for bending and extend in the longitudinal direction of the tube.

A feature of the prior art is the use of a metal wire as a means to conduct electrical current along the length of the tube, even though conductive elastomers may be included as components of the switch. The necessity of employing a metal wire adds to the expense of making the switch. It would be advantageous to have a tubular switch wherein the metal wire conductors are not needed.

### SUMMARY

A seamless elongate pressure actuated switch is provided herein which includes: (a) a seamless tubular sheath fabricated from a resiliently flexible non-conductive polymeric resin, the sheath having an inside wall defining a lengthwise extending axial bore; (b) first and second separate and spaced apart conductive electrode films disposed lengthwise along the inside wall of the sheath, wherein the sheath is deformably movable in response to pressure applied thereto between a first position wherein the first and second conductive electrode films are not in electrical contact with each other and a second position wherein the first and second conductive electrode films are in electrical contact with each other, and wherein the first and second conductive electrode films are the only means of conducting electricity lengthwise along the inside wall of the sheath.

Also provided herein is a method for making the seamless switch. The method includes providing a fluid coating composition including a polymeric binder, a conductive filler including a metal selected from the group consisting of powdered silver, copper, gold, zinc, aluminum, nickel, silver coated copper, silver coated glass particles, silver coated aluminum, graphite or carbon, and a solvent and/or diluent; passing a quantity of the fluid coating composition through the axial bore of the tubular member so as to coat the inside wall; drying the coating composition to leave a non-fluid conductive layer on the inside wall; and, dividing the conductive layer into first and second separate spaced apart conductive electrode films.

### BRIEF DESCRIPTION OF THE DRAWINGS

Various embodiments of the invention are described below with reference to the drawings wherein:

FIG. 1 is a diagrammatic illustration of a method for making a seamless elongate pressure actuated switching device;

FIG. 2, is a perspective view of a seamless elongate pressure actuated switching device;

FIG. 3 illustrates the seamless elongate pressure actuated switching device in an actuated condition;

FIG. 4 is a diagrammatic view of a hot wire cutting implement;

FIG. 5 is a partly cut away sectional view illustrating the making of the seamless elongate pressure actuated switching device using the hot wire cutting implement;

FIGS. 6 and 7 are, respectively, side sectional and end sectional views of a die head for the manufacture of the seamless elongate pressure actuated switching device by coextrusion; and

FIG. 8 is a sectional view of the elongate pressure actuated switching device in conjunction with a terminal.

### DETAILED DESCRIPTION OF PREFERRED EMBODIMENT(S)

As used herein the terms “conductive”, “resistance”, “insulative” and their related forms, pertain to the electrical properties of the materials described, unless indicated otherwise. The terms “top”, “bottom”, “upper”, “lower” and like terms are used relative to each other. The terms “elastomer” and “elastomeric” are used herein to refer to a material that can undergo at least about 10% deformation elastically. Typically, elastomeric materials suitable for the purposes described herein include polymeric materials such as plasticized polyvinyl chloride (“PVC”), thermoplastic polyurethane, natural and synthetic rubbers and the like. Composition percentages are by weight unless specified otherwise. Except for the claims all quantities are modified by the term “about”.

“Resistance” refers to the opposition of the material to the flow of electric current along the current path and is measured in ohms. Resistance increases in proportion to the length of the current path and the specific resistance, or “resistivity”, of the material, and it varies inversely to the amount of cross-sectional area available to the current path. The resistivity is a property of the material and may be thought of as a measure of (resistance/length)×area. More particularly, the resistance may be determined in accordance with the following formula:

R=(ρL)/A (I)

wherein

R=resistance in ohms

ρ=resistivity in ohm-inches

L=length in inches

A=area in square inches.

The current through a circuit varies in proportion to the applied voltage and inversely with the resistance as provided by Ohm's Law:

I=V/R (II)

wherein

I=current in amperes

V=voltage in volts

R=resistance in ohms.

Typically, sheet resistance, i.e., the resistance of a flat conductive sheet across the plane of the sheet from one edge to the opposite edge, is measured in units of ohms per square. For any given thickness of the conductive sheet, the resistance value across the square remains the same no matter what the size of the square is. In applications where the current path is from one surface to another, i.e., in a direction perpendicular to the plane of the sheet, resistance is measured in ohms.

The reciprocal of resistance R is conductivity which is measured in “mhos”:

C=1/R (III)

wherein

C=conductivity in mhos

R=resistance in ohms.

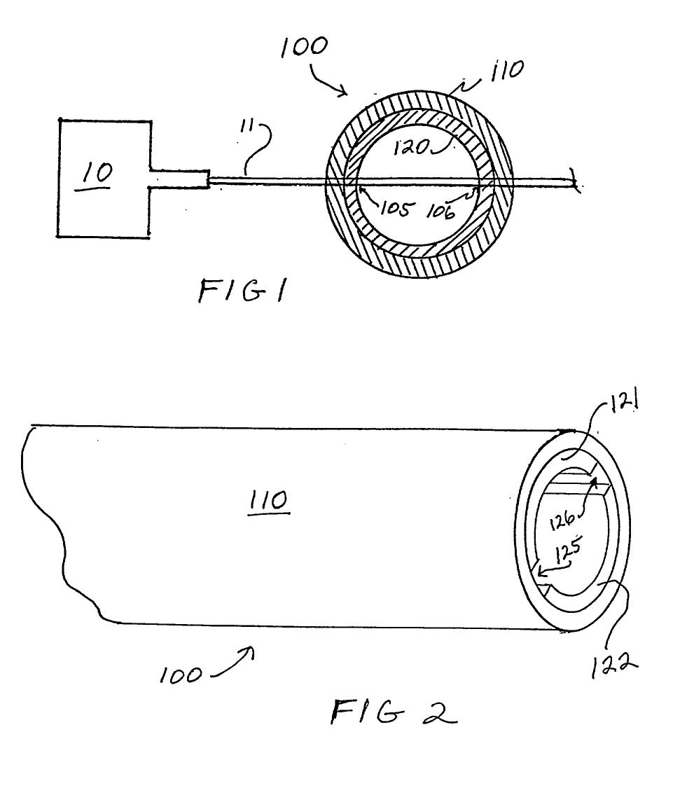

Referring to FIGS. 1 and 2, an elongate pressure actuated switch and method for making an elongate pressure actuated switch are illustrated. More particularly, in a first step there is provided an elongated pressure actuated switch 100 includes a seamless tubular outer sheath 110 having an internal surface defining an axial bore. Sheath 110 is fabricated from a non-conductive polymeric resin which is resiliently flexible and preferably transparent. For example, sheath 110 is preferably fabricated by extrusion from plasticized polyvinyl chloride (“PVC”), polyurethane, silicone, or natural or synthetic rubber. A suitable commercially available sheath material is TYGON® brand tubing which is made from PVC.

In a second step a conductive coating composition is applied to the internal surface of the sheath. The coating composition is a fluid which contains a binder such as a polymeric resin, a conductive filler, and a solvent and/or diluent. The binder can be, for example, polyurethane, PVC, and the like. The conductive filler is preferably a finely powdered conductive material such as powdered metal (e.g., copper, silver, gold, zinc, aluminum, nickel), a metal coated powder (e.g., silver coated copper, silver coated glass particles, silver coated aluminum), graphite powder, graphite fibers or carbon (e.g., carbon black). Powdered metal, especially powdered silver, is preferred. In organic solvent systems the solvent can be a ketone (e.g., methylethyl ketone, diethyl ketone, acetone, etc.), an ether (e.g., tetrahydrofuran, etc.), an ester (e.g., butyl acetate, etc.), an alcohol (e.g., isopropanol, ethanol, methanol, etc.) an aromatic hydrocarbon (e.g., toluene, xylene, etc.) or any other fluid suitable for dissolving the selected binder. In aqueous systems water is used as the diluent for aqueous emulsions and may optionally include a surfactant. Suitable coating compositions are set forth below in Tables I and II.

Table I
Organic solvent system
(Composition in parts by weight)

| | Broad Range | Preferred Range |
|---|---|---|
| Binder | 1-5 | 2-4 |
| Polyurethane resin | | |
| (28.9% solids in tetrahydrofuran) | | |
| Conductive Filler | 5-10 | 8-10 |
| Silver pigment | | |
| Diluent | 20-300 | 30-40 |
| Methylethyl ketone | | |

An aqueous coating composition suitable for use in the method described herein is set forth below in Table II:

TABLE II
Aqueous system
(Composition in parts by weight)

| | Broad Range | Preferred Range |
|---|---|---|
| Binder | 2-10.7 | 7-8 |
| Polyurethane resin | | |
| (40% solids in an aqueous | | |
| emulsion or latex) | | |
| Conductive Filler | 5-10 | 8-10 |
| Silver pigment | | |
| Diluent | 20-300 | 30-40 |
| Deionized water with surfactant | | |

In a third step the fluid coating composition is applied to the interior surface of the sheath. A suitable method of applying the fluid coating composition is to pump a quantity of the fluid coating composition through the bore of the sheath. Preferably, substantially the entire interior surface of the sheath is coated in such a manner.

In a fourth step the fluid coating is dried to form a non-fluid conductive layer 120 along the interior surface of the sheath 110 and concentric with the sheath. Drying can be accomplished by blowing warm dry air or nitrogen through the bore of sheath 110. In the dried coating the composition percentage of the conductive filler preferably can range from about 30% to 95%. The conductive layer 120 is elastomeric and can range in thickness from 0.1 mils to 10 mils (1.0 mil=0.001 inches). The resistance of the conductive layer 120 depends at least in part on the type and composition percentage of conductive filler and the dimensions of the layer. For most applications a resistance value ranging from 300 ohms per square down to 0.001 ohms per square is appropriate. In terms of specific resistance, the conductive layer of the present invention can possess a resistivity about as low as that of silver (i.e., about 1.59 microhm-cm), or higher, depending on the percentage and type of conductive filler. This low resistivity allows the elongated pressure actuated switch of the present invention to be used without conductive wires extending through the interior of the sheath. Rather, in a preferred embodiment the conductive electrode films 121 and 122 formed from conductive layer 120 are the only means for conducting electricity lengthwise along the inside wall of the sheath 110. The conductive electrode films are adapted to carry a current load of up to 5 amps/cm².

In another step of the present invention the conductive layer 120 is divided into two separate and spaced apart conductive films to form two contact electrodes.

One method of achieving the division of the conductive layer 120 is by employing a beam of high energy radiation. Referring to FIG. 1, a beam 11 of radiation is directed laterally through sheath 110 along the length of sheath 110 from a radiation source 10. Radiation beam 11 can be a gamma ray beam, X-ray beam, electron beam, or laser beam. The beam passes through sheath 110 and successively strikes the conductive layer 120 at points 105 and 106 where it is absorbed by the conductive metal filler (e.g., the silver powder) and causes heating. The intensity of the beam is selected such that the heating is sufficient to burn away the binder of the conductive layer, thereby forming void spaces. The sheath can be moved longitudinally such that the beam forms two elongated parallel void spaces in the conductive layer 120 extending along the length of the sheath 110, either simultaneously in one operation or in successive operations to form a pressure actuated switch as shown in FIG. 2. Referring the FIG. 2, elongated pressure actuated switch 100 includes sheath 110, and first and second spaced apart conductive electrode films 121 and 122 which are at least partially defined by elongated void spaces 125 and 126. The width of the beam 11 corresponds to the desired width of the void spaces 125 and 126.

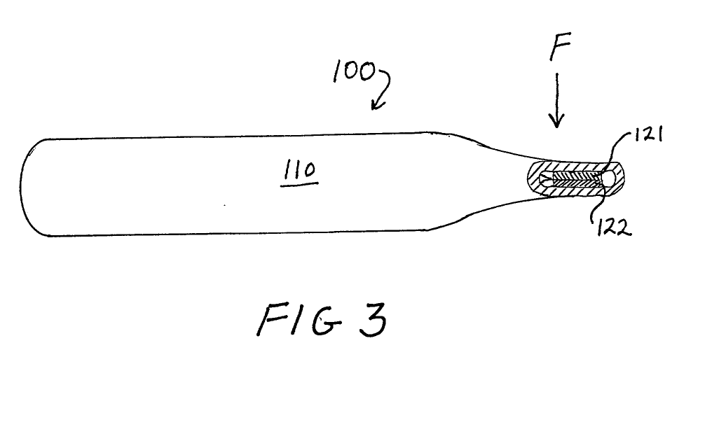

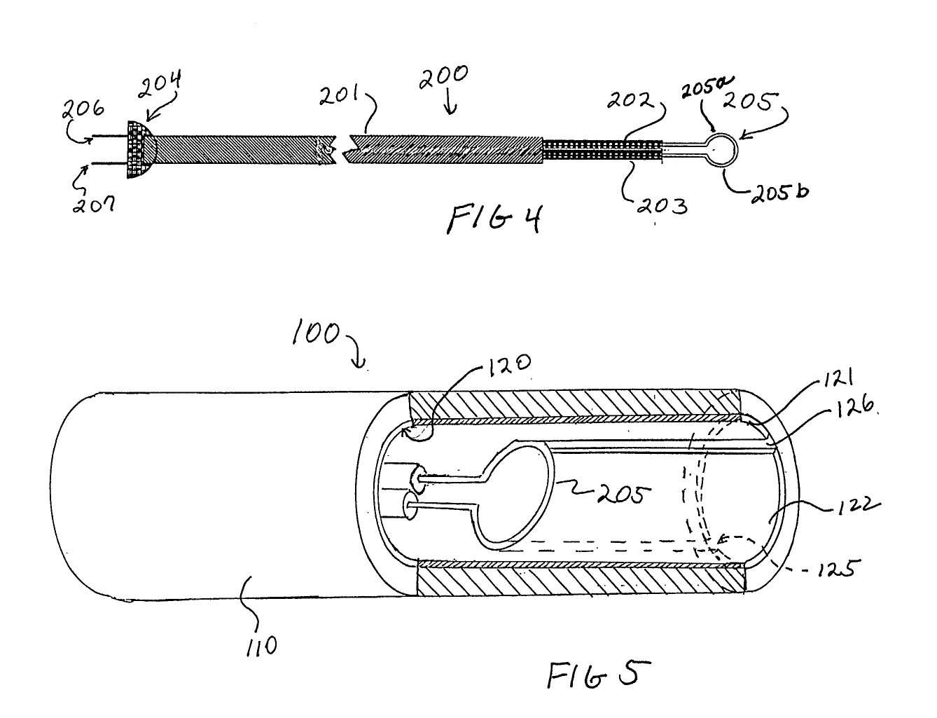

Referring to FIG. 3, upon the application of force F at some point along the length of the elongated pressure actuated switch 100, sheath 110 deforms under pressure, thereby bringing conductive electrode films 121 and 122 into physical and electrical contact and thereby closing the switch to allow current to pass. Each conductive electrode film 121 and 122 can be individually connected to a respective wire lead by means of a termination method and device described below, and incorporated into an electrical circuit for controlling the operation of a motorized device such as a movable door. The conductive electrode films 121 and 122 are the only interior means of conducting electricity along the length of the pressure actuated switch 100. No interior lengthwise conductive wires are needed.

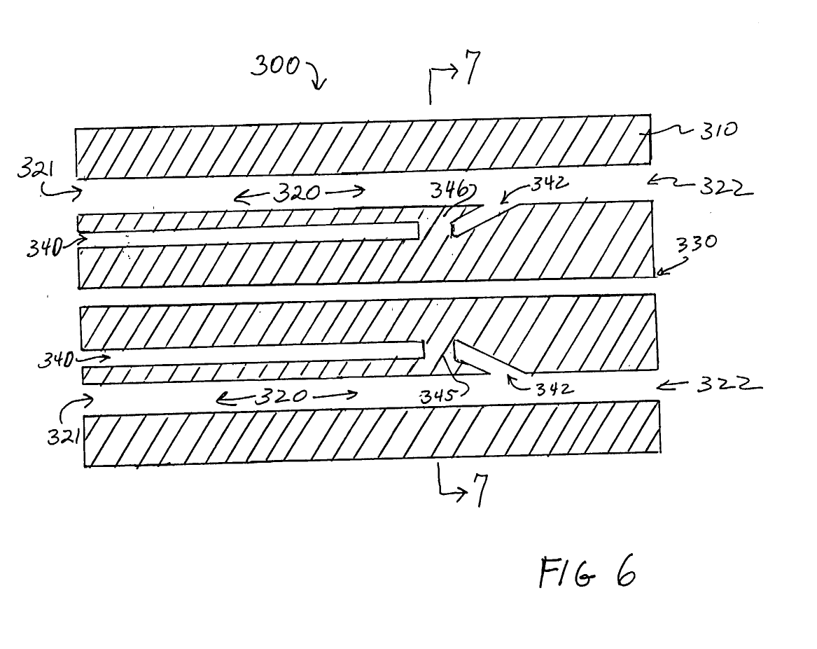

Referring to FIGS. 4 and 5 an implement and alternative method of making the elongated pressure actuated switch 100 are illustrated. More particularly, referring to FIG. 4, hot wire cutter 200 includes an elongated outer body cover 201 having an axial bore through which insulated wires 202 and 203 are disposed. The wires terminate in an exposed distal cutting tip 205, which is a heating element with two laterally extending portions 205a and 205b, and which may be in a circular configuration, as shown, or in an oval, triangular, square or other configuration. Proximal end portion 204 includes connecting terminals 206 and 207 of the conductive wires 202 and 203, respectively. When terminals 206 and 207 are connected to a power source and electric current is sent through wires 202 and 203, the cutting tip is heated by resistance heating. The temperature is regulated such that the temperature of the cutting tip is sufficiently hot to melt the binder resin of the conductive coating. The hot wire cutter is configured and dimensioned so as to slidingly fit within the bore of sheath 110.

Referring to FIG. 5, to make the pressure actuated switch 100, a sheath 110 is provided with a dried conductive layer 120. The unenergized cutter 200 with a cold cutting tip 205 is inserted through the bore of sheath 110. The tip is then energized until it becomes sufficiently hot to melt the binder resin of the conductive layer 120. The cutter 200 is then moved proximally through the sheath with the lateral portions 205a and 205b of the cutting tip 205 in contact with the conductive layer 120. As the cutting tip moves through the sheath 110 it forms two opposite linear voids 125 and 126 in the conductive layer which divide the conductive layer 120 into two spaced apart opposing conductive electrode coatings 121 and 122.

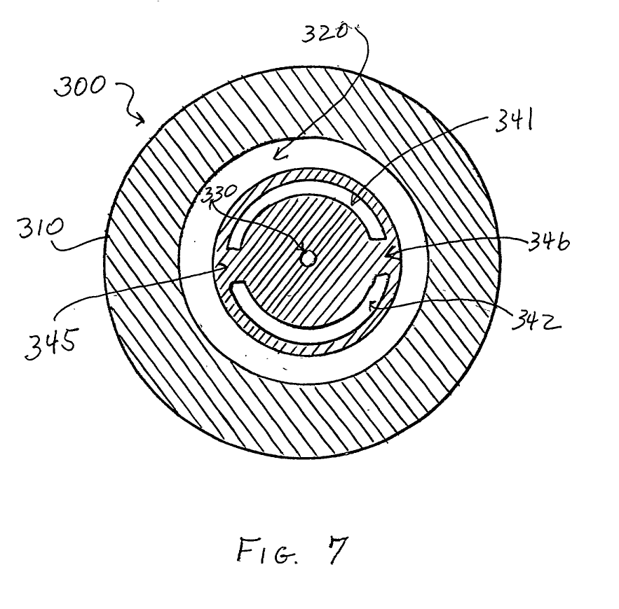

In yet another feature of the present invention the elongated pressure actuated switch can be fabricated by means of coextrusion. Various methods and apparatus for coextrusion of layered polymers are known to those with skill in the art. For example, apparatus and methods for coextrusion are described in U.S. Pat. Nos. 3,184,358, 3,223,761, 3,275,725, 3,640,659, 3,890,083, 3,947,173, 4,125,585, 4,161,379, 4,236,884, 4,244,914, 4,248,824, 5,853,770, 5,882,694, all of which are incorporated by reference herein. Referring now to FIGS. 6 and 7, a die head 300 for coextrusipn of the elongated pressure actuated switching device 100 is illustrated. Die head 300 includes a body 310 having an annular channel 320 for passage therethrough of the polymeric material for sheath 110. The annular channel 320 terminates in distal exit opening 322. Molten polymer sheath material flows into channel 320 through proximal access opening 321. A concentric annular channel 340 has a smaller diameter than channel 320 and is provided for conveying the conductive electrode coating material. Blocking barriers 345 and 346 divide the flow of conductive electrode coating material in channel 340, and direct the flow of conductive electrode coating material, into two channel portions 341 and 342, which flare outward to join channel 320. A central axial channel 330 is provided for compressed gas. In operation fluid polymeric sheath material is sent through channel 320 and an extrudable conductive electrode material is sent through channel 340. The conductive electrode material is divided into two spaced apart sections 341 and 342 by barriers 345 and 346 and is joined to the interior surface of the sheath by entering into channel 320. The die head is heated to maintain the polymeric in a fluid state. Upon exiting at opening 322 the polymeric material is chilled so as to solidify. Compressed gas (air, nitrogen, carbon dioxide, etc.) is pumped through channel 330 to prevent the sheath from collapsing in upon itself while in the softened state at the exit opening 322. The resulting elongated switch 100 is as shown in FIG. 2.

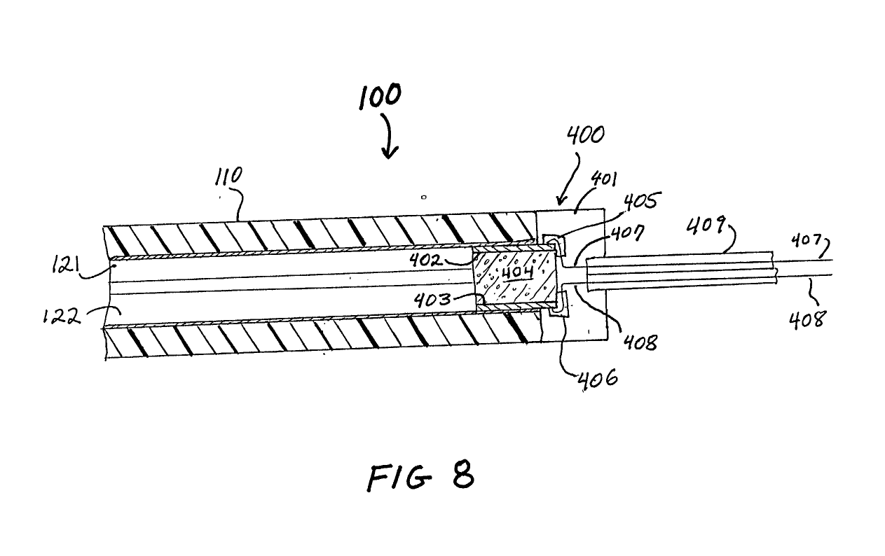

Referring now to FIG. 8, elongate pressure actuated switch 100 is terminated by a terminal plug 400 which seals the end of tubular sheath 110 and provides means for electrical connection to an electrical circuit. More specifically, terminal plug 400 includes a body portion 401 of insulating material such as solid polymeric resin. Extending from the body portion 401 is a projection which includes first and second electrode contact 402 and 403, and a resiliently compressible non-conductive polymeric foam member 404 between the first and second electrode contacts 401 and 402. First electrode contact 402 is adapted to contact first conductive electrode film 121. Second electrode contact 403 is adapted to contact second conductive electrode film 122. The foam member 404 resiliently biases the first and second electrode contacts 402 and 403 away from each other so as to facilitate the contacting between the electrode contacts 402 and 403 and the respective conductive electrode films 121 and 122. The first and second electrode contacts 402 and 403 can be fabricated from metal foils or sheets. The foam member 404 can be, for example, an expanded cellular polyurethane, plasticized PVC, silicone, rubbers and the like. Clips 405 and 406 secure the first and second electrode contacts 402 and 403 within the body portion 401. Electrically conductive wires 407 and 408 are connected to clips 405 and 406 and make electrical contact with the respective electrode contacts 402 and 403. Wires 407 and 408 may be connected to an electrical control circuit. Sheath 409 insulates the wires 407 and 408.

The opposite end of the pressure actuated switch 100 may be terminated by a simple, non-electrical plug to seal the end of the sheath and prevent the entry of moisture, debris, and unwanted matter into the interior of the pressure actuated switch 100.

While the above description contains many specifics, these specifics should not be construed as limitations on the scope of the invention, but merely as exemplifications of preferred embodiments thereof. Those skilled in the art will envision many other possibilities within the scope and spirit of the invention as defined by the claims appended hereto.

What is claimed is:

1. A seamless elongated pressure actuated switch which comprises:
a) a seamless tubular sheath fabricated from a resiliently flexible non-conductive polymeric resin, the sheath having an inside wall defining a lengthwise extending axial bore;
b) first and second separate and spaced apart conductive electrode films disposed lengthwise along the inside wall of the sheath,
wherein the sheath is deformably movable between a first position wherein the first and second conductive electrode films are not in electrical contact with each other and a second position wherein the first and second conductive electrode films are in electrical contact with each other, wherein said first and second conductive electrode films are the only means of conducting electricity lengthwise along the inside wall of the sheath.

2. The switch of claim 1 wherein the first and second conductive electrode films each have a thickness of from about 0.01 mils to about 10 mils and an electrical resistivity of from about 300 ohms per square to about 0.001 ohms per square.

3. The switch of claim 1 wherein the first and second conductive coatings each comprise a polymeric binder and a powdered conductive filler including a material selected from the group consisting of powdered copper, silver, gold, zinc, aluminum, nickel, silver coated copper, silver coated glass particles and silver coated aluminum.

4. The switch of claim 3 wherein the polymeric binder comprises polyurethane.

5. The switch of claim 1 wherein the seamless sheath has a circular annular cross section.

6. The switch of claim 1 wherein the sheath is fabricated from polyvinyl chloride.

7. The switch of claim 1 wherein the sheath is transparent.

8. A method for making an elongated pressure actuated switch, comprising the steps of:
a) providing a seamless tubular member fabricated from a resiliently flexible non-conductive polymeric resin, the tubular member having an inside wall defining a lengthwise extending axial bore;
b) providing a fluid conductive coating composition comprising a polymeric binder, a particulate conductive filler;
c) passing a quantity of the fluid conductive composition through the axial bore of the tubular member so as to coat the inside wall;
d) drying the conductive composition to leave a non-fluid conductive layer on the inside wall; and,
e) dividing the conductive layer into first and second separate spaced apart conductive electrode films.

9. The method of claim 8 wherein the step of dividing the conductive layer comprises directing a beam of radiation laterally through the tubular member along the length of the tubular member said radiation being of sufficient intensity to burn away the conductive film in the path of said beam so as to form at least one linear non-conductive void space.

10. The method of claim 8 wherein the radiation comprises an energy beam selected from the group consisting of gamma rays, X-rays, electron beam and laser beam.

11. The method of claim 8 wherein the step of dividing the conductive layer comprises
providing an implement having a body configured and dimensioned to be movably disposed within the axial bore of the tubular member, the implement having at least one heating element and two laterally extending heating element portions,
raising the temperature of the heating element portions sufficient to melt the conductive layer; and
moving said implement body though the axial bore of the tubular member while contacting the heating element portions with the non-fluid conductive layer so as to form two parallel non-conductive void spaces.

12. The method of claim 8 wherein the conductive filler comprises a material selected from the group consisting of copper, silver, gold, zinc, aluminum, nickel, silver coated copper, silver coated glass particles, silver coated aluminum, graphite and carbon.

13. The method of claim 8 wherein the fluid coating composition includes a solvent selected from the group consisting of methylethyl ketone, diethyl ketone, acetone, tetrahydrofuran, butyl acetate, isopropanol, ethanol, methanol, naphtha, toluene and xylene.

14. The method of claim 8 wherein the fluid coating composition includes water.

15. The method of claim 8 wherein the seamless tubular member includes two ends, and the method further includes the steps of
a) providing an electrical plug having a first electrical contact surface and a second electrical contact surface, and first and second conductive wires extending respectively from said first and second electrical contact surfaces; and
b) inserting said electrical plug into at least one end of the tubular member such that the first electrical contact surface is in electrical contact within the first conductive electrode film and the second electrical contact surface is in electrical contact with the second conductive electrode film.

16. A method for making an elongated pressure actuated switch comprising:
a) providing a quantity of polymeric resin;
b) providing a quantity of extrudable coating material which includes a polymeric binder and a conductive filler; and
c) coextruding the polymeric resin and conductive coating material such that the polymeric resin is formed into the seamless tubular sheath with the conductive coating material deposited along the inside wall of the sheet in the form of two spaced apart conductive coatings.

17. The method of claim 16 wherein the seamless tubular member includes two ends, and the method further includes the steps of
a) providing an electrical plug having a first electrical contact surface and a second electrical contact surface, and first and second conductive wires extending respectively from said first and second electrical contact surfaces; and
b) inserting said electrical plug into at least one end of the tubular member such that the first electrical contact surface is in electrical contact with the first conductive electrode film and the second electrical contact surface is in electrical contact with the second conductive electrode film.

18. The method of claim 16 wherein the conductive filler comprises a material selected from the group consisting of copper, silver, gold, zinc, aluminum, nickel, silver coated copper, silver coated glass particles, silver coated aluminum, graphite powder, graphite fibers and carbon.

19. The method of claim 16 wherein the fluid coating composition includes a solvent selected from the group consisting of methylethyl ketone, diethyl ketone, acetone, tetrahydrofuran, butyl acetate, isopropanol, ethanol, methanol, naphtha, toluene and xylene.
